(19) United States
(12) Patent Application Publication
(10) Pub. No.: US 2022/0073815 A1
(43) Pub. Date: Mar. 10, 2022

(54) METHOD FOR PRODUCING QUANTUM DOT DISPERSION AND QUANTUM DOT DISPERSION

(71) Applicant: TOKYO OHKA KOGYO CO., LTD., Kanagawa (JP)

(72) Inventors: Yueh Chun LIAO, Kanagawa (JP); Takehiro SESHIMO, Kanagawa (JP); Kunihiro NODA, Kanagawa (JP)

(21) Appl. No.: 17/417,997

(22) PCT Filed: Dec. 24, 2019
(86) PCT No.: PCT/JP2019/050719

§ 371 Date: Jun. 24, 2021

(30) Foreign Application Priority Data
Dec. 25, 2018 (JP) 2018-241733

(51) Int. Cl. C09K 11/02; C09K 11/70; C09K 11/08; C09D 5/22; C09D 7/62

(52) U.S. Cl. CPC C09K 11/025; C09K 11/703; B82Y 40/00; C09D 5/22; C09D 7/62; C09K 11/0883

(57) ABSTRACT

Provided are: a method for producing a quantum dot dispersion enabling formation of a substrate having quantum dots or a film comprising quantum dots which exhibits desired quantum dots, when the quantum dot dispersion is used for dispersing quantum dots on a surface of the substrate or preparing a composition for producing the film containing quantum dots, and a quantum dot dispersion that can be suitably produced by the above method. The quantum dot dispersion is produced by using quantum dots containing chalcogenide as a material of surface and dispersing the quantum dots (A) in the dispersion medium (B) comprising an organic solvent (B1) comprising a chalcogen element.

### TECHNICAL FIELD

The present invention relates to a method for producing quantum dot dispersion and quantum dot dispersion. Related Art

### BACKGROUND ART

An extremely small grain (dot) formed to confine electrons has been conventionally called a quantum dot, and the application thereof in a variety of fields has been investigated. Here, the size of one quantum dot is from several nanometers to tens of nanometers in diameter.

Such quantum dot can be used as a wavelength conversion material, since the quantum dot can change light-emitting fluorescent color (emission wavelength) (wavelength conversion) by changing the size thereof (changing band gap). Because of this, it has been diligently investigated that quantum dots are applied to a display element as a wavelength conversion material in recent years (see Patent Documents 1 and 2).

In addition, it has been investigated that an optical film including quantum dots is applied to various optical light-emitting elements and display elements. For example, it has been proposed that a quantum dot sheet including quantum dots dispersed in a matrix made of various polymeric materials is used as an optical film (see Patent Document 3). For example, when light rays emitted from a light source are allowed to pass through an optical film including quantum dots in elements to show an image using light emission of a light source such as a liquid crystal display element and an organic EL display element, green light and red light, which have high color purity, can be extracted by wavelength conversion. Therefore, the range of hue reproduction can be enlarged.
Patent Document 1: Japanese Unexamined Patent Application, Publication No. 2006-216560
Patent Document 2: Japanese Unexamined Patent Application, Publication No. 2008-112154
Patent Document 3: Korean Patent Application No. 10-2016-0004524

### DISCLOSURE OF THE INVENTION

### Problems to be Solved by the Invention

Quantum dots are often used in the form of dispersion for the purpose of dispersing quantum dots on the substrate surface or preparing compositions to form films containing dispersed quantum dots. However, in the case in which conventionally known dispersion of quantum dots, a substrate having quantum dots or a film containing quantum dots does not often exhibit desired quantum yield.

The present invention has been made in view of the above problem and an object of the present invention is to provide a method for producing a quantum dot dispersion enabling formation of a substrate having quantum dots or a film comprising quantum dots which exhibits desired quantum dots, when the quantum dot dispersion is used for dispersing quantum dots on a surface of the substrate or preparing a composition for producing the film containing quantum dots, and a quantum dot dispersion that can be suitably produced by the above method.

### Means for Solving the Problems

The present inventors have found that the above-mentioned problem can be solved by using quantum dots (A) containing a chalcogenide as a surface material and producing a quantum dot dispersion by dispersing the quantum dots (A) in a dispersion medium (B) including an organic solvent (B1) containing a chalcogen element, and accomplished the present invention. Specifically, the present invention provides the following.

A first aspect of the present invention is a method for producing a quantum dot dispersion in which quantum dots (A) are dispersed in a dispersion medium (B), the method comprising:

dispersing the quantum dots (A) in the dispersion medium (B), wherein a material of surface of the quantum dots (A) comprises a chalcogenide,
a ligand can bound to the surface of the quantum dots (A), and the dispersion medium (B) comprises an organic solvent (B1) comprising a chalcogen element.

A second aspect of the present invention is a quantum dot dispersion in which quantum dots (A) are dispersed in dispersion medium (B),

wherein a material of surface of the quantum dots (A) comprises a chalcogenide,
a ligand can bound to the surface of the quantum dots (A), and the dispersion medium (B) comprises an organic solvent (B1) comprising a chalcogen element.

### Effects of the Invention

According to the present invention, a method for producing a quantum dot dispersion enabling formation of a substrate having quantum dots or a film comprising quantum dots which exhibits desired quantum dots, when the quantum dot dispersion is used for dispersing quantum dots on a surface of the substrate or preparing a composition for producing the film containing quantum dots, and a quantum dot dispersion that can be suitably produced by the above method can be provided.

### PREFERRED MODE FOR CARRYING OUT THE INVENTION

### <<Method for Producing Quantum Dot Dispersion>>

Method for producing quantum dot dispersion is a method for producing a quantum dot dispersion in which a quantum dots (A) are dispersed in a dispersion medium (B). The method includes dispersing the quantum dots (A) in the dispersion medium (B). a ligand can bound to the surface of the quantum dots (A). The ligand is a substance that binds to the surface of the quantum dots (A), not a material that makes up the surface of the quantum dots (A). The quantum dot dispersion produced by the above method is preferably a non-curable composition, which does not cure by the action of light, heat and the like, due to its excellent stability as a dispersion and the ease of preparation of a composition for producing a film using the dispersion solution.

For the quantum dots (A), quantum dots whose surface material is made of a material containing chalcogenide are used. For the dispersion medium (B), a dispersion medium including an organic solvent (B1) comprising a chalcogen element is used. A substrate having the quantum dots (A) or a film including the quantum dots (A) that exhibits desired quantum yield can be easily formed by using the quantum dot dispersion produced by using such a quantum dots (A) in combination with such a dispersion medium (B). Particularly, in the case in which the substrate having the quantum dots (A) or the film including quantum dots (A) is heated or exposed to light in oxygen-rich atmosphere, the substrate having the quantum dots (A) or the film including quantum dots (A) that exhibits desired quantum yield often can not be formed. However, when the quantum dot dispersion produced by the above method is used, even if the quantum yield is lowered due to heating or exposure of the film including quantum dots (A) or the substrate having the quantum dots (A) in an oxygen-rich atmosphere, the quantum yield can be recovered by heating the substrate or the film in a non-oxidative atmosphere. This is probably due to the adhesion of the organic solvent (B1) comprising the chalcogen element to the quantum dots (A) contained in the substrate or the film that exhibits lowered quantum yield. In the quantum dots (A) contained in the substrate or the film that exhibits lowered quantum yield, it is thought that the chalcogenide on a surface is oxidized. By heating oxidized quantum dot, the quantum yield of the substrate or the film is considered to be recovered to a high value, as a reaction to replace the oxygen in the quantum dots (A) with the chalcogen element between the organic solvent (B1) comprising the chalcogen element and the oxidized quantum dots (A) occurs by heating oxidized quantum dots (A) under non-oxidative atmosphere. By heating oxidized quantum dot, the quantum yield of the substrate or the film is considered to be recovered to a high value, as a reaction to replace the oxygen in the quantum dots (A) with the chalcogen element between the organic solvent (B1) comprising the chalcogen element and the oxidized quantum dots (A) occurs by heating oxidized quantum dots (A) under non-oxidative atmosphere. The non-oxidative atmosphere is exemplified by an inert gas atmosphere, a reduced pressure atmosphere and a vacuum atmosphere. Preferable non-oxidative atmosphere is exemplified by a nitrogen gas atmosphere, a forming gas atmosphere and a hydrogen gas atmosphere. Heating temperature under the non-oxidative atmosphere is preferably 110° C. or higher and 300° C. or lower, more preferably 110° C. or higher and 280° C. or lower, further preferably 120° C. or higher and 250° C. or lower, and particularly preferably 130° C. or higher and 200° C. or lower. Heating time under the non-oxidative concentration atmosphere is preferably 5 minutes or longer and 1 day or shorter, more preferably 10 minutes or longer and 12 hours or shorter, and particularly preferably 20 minutes or longer and 1 hour or shorter.

Hereinafter, quantum dots (A), a dispersion medium (B), other component which may be contained in the quantum dot dispersion, and dispersing method will be described.

### <Quantum Dots (A)>

The liquid composition includes the quantum dots (A). As long as the quantum dots (A) are microparticles that function as quantum dots and the material of surface is a material containing chalcogenide, the structure and components of the quantum dots (A) are not particularly limited. The quantum dots (A) are a nanoscale material having particular optical characteristics according to quantum mechanics (quantum-confined effect described below), and commonly mean semiconductor nanoparticles. In the description, the quantum dots (A) also include quantum dots in which the surface of semiconductor nanoparticles is further covered to improve a luminescent quantum yield (quantum dots having a shell structure described below) and quantum dots which are surface-modified for stabilization. However, as mentioned above, in the specification of this application, the ligand and the like used for surface modification is assumed to be a different material from the quantum dots (A).

A chalcogenide is not particularly limited as long as it is a compound containing an inorganic element well-known as a component of a quantum dot and a chalcogen element. Here, the chalcogen elements contained in the chalcogenide are group 6B elements (old UIPAC) which are S, Se, and Te. The chalcogen elements are more preferably S and Se.

The structure of quantum dots (A) can be a homogeneous structure made of one compound, or a composite structure made of two or more compounds. In order to improve luminescent quantum yields of the above compounds, the structure of quantum dots (A) is preferably a core-shell structure in which the core is covered with one or more shell layers, and more preferably a structure in which the surface of a particle of the compound, a core material, is epitaxially covered with a semiconductor material. In the specification and claims of the present application, particles in the process of manufacturing quantum dots (A) of core-shell structure are not included in quantum dots (A).

When group II (group 2A and group 2B (old IUPAC))—group VI (group 6B (old IUPAC)) CdSe, for example, is used as a core material, ZnS, ZnSSe and the like are used as its covering layer (shell). The shell preferably has the same lattice constant as a core material has. A material combination in which the difference in the lattice constant between the core and shell is small is properly selected.

The quantum dots (A) are considered as semiconductor nanoparticles which absorb photons having energy larger than a band gap (a difference in energy between a valence band and a conduction band) and emit light with a wavelength depending on the particle diameter thereof. Elements contained in a material of the quantum dots (A) is exemplified by at least one selected from the group consisting of group II elements (group 2A and 2B (old IUPAC)), group III elements (especially group 3B (old IUPAC)), group IV elements (especially group 4B (old IUPAC)), group V elements (especially group 5B (old IUPAC)) and group VI elements (especially group 6B elements (old IUPAC)). Examples of preferred compounds or elements as materials for the quantum dots (A) includes group II-VI compounds, group III-V compounds, group IV-VI compounds, group IV elements, group IV compounds and combinations thereof.

Examples of group II-VI compounds include at least one compound selected from the group consisting of at least one compound selected from the group consisting of CdSe, CdTe, ZnS, ZnSe, ZnTe, HgS, HgSe, HgTe, MgSe, MgS and mixtures thereof; at least one compound selected from the group consisting of CdSeS, CdSeTe, CdSTe, ZnSeS, ZnSeTe, ZnSTe, HgSeS, HgSeTe, HgSTe, CdZnS, CdZnSe, CdZnSe, CdHgS, CdHgSe, CdHgSe, HgZnS, HgZnSe, HgZnSe, MgZnSe, MgZnS and mixtures thereof; and at least one compound selected from the group consisting of HgZnTeS, CdZnSeS, CdZnSeTe, CdZnSTe, CdHgSeS, CdHgSeTe, CdHgSTe, HgZnSeS, HgZnSeTe, HgZnSTe and mixtures thereof. All of these are chalcogenides containing at least one selected from S, Se and Te. Therefore, all of these can be used as materials for the surface of the quantum dots (A).

Among these, at least one compound selected from the group consisting of CdSe, ZnS, ZnSe, HgS, HgSe, MgSe, MgS and mixtures thereof; at least one compound selected form the group consisting of CdSeS, CdSeTe, CdSTe, ZnSeS, ZnSeTe, ZnSTe, HgSeS, HgSeTe, HgSTe, CdZnS, CdZnSe, CdHgS, CdHgSe, HgZnS, HgZnSe, MgZnSe, MgZnS and mixtures thereof; and at least one compound selected form the group consisting of HgZnTeS, CdZnSeS, CdZnSeTe, CdZnSTe, CdHgSeS, CdHgSeTe, CdHgSTe, HgZnSeS, HgZnSeTe, HgZnSTe and mixtures thereof are preferable.

Examples of group III-V compounds include at least one compound selected from GaN, GaP, GaAs, GaSb, AlN, AlP, AlAs, AlSb, InN, InP, InAs, InSb and mixtures thereof; at least one compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP and mixtures thereof; and at least one compound selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb and mixtures thereof.

Examples of group IV-VI compounds include at least one compound selected from SnS, SnSe, SnTe, PbS, PbSe, PbTe and mixtures thereof; at least one compound selected from SnSeS, SnSeTe, SnSTe, PbSeS, PbSeTe, PbSTe, SnPbS, SnPbSe, SnPbSe and mixtures thereof; and at least one compound selected from SnPbSSe, SnPbSeTe, SnPbSTe and mixtures thereof. All of these are chalcogenides containing at least one selected from S, Se and Te. Therefore, all of these can be used as materials for the surface of the quantum dots (A). Among these, at least one compound selected from SnS, SnSe, PbS, PbSe, and mixtures thereof; at least one compound selected from SnSeS, SnSeTe, SnSTe, PbSeS, PbSeTe, PbSTe, SnPbS, SnPbSe and mixtures thereof; and at least one compound selected from SnPbSSe, SnPbSeTe, SnPbSTe and mixtures thereof; is preferable.

Examples of group IV elements include at least one compound selected from Si, Ge and mixtures thereof. Examples of group IV compounds include at least one compound selected from SiC, SiGe and mixtures thereof.

The quantum dots (A) preferably include a compound including Cd or In as a constituent from the viewpoint of fluorescence efficiency, and more preferably include a compound including In as a constituent when taking into account safety.

Specific suitable examples of quantum dots (A) of the homogeneous structure type not having a shell layer include AgInS₂ and Zn-doped AgInS₂. Examples of quantum dots (A) of the core-shell type include InP/ZnS, InP/ZnSSe, CuInS₂/ZnS, and (ZnS/AgInS₂) solid solution/ZnS. It should be noted that materials for quantum dots (A) of the core-shell type are described as (core material)/(shell layer material) in the above description.

A shell of the core-shell structure has preferably a multi-layer structure from the viewpoint of improvement of safety and a luminescent quantum yield and more preferably two layers. In a core-multilayer shell structure, the material of the core is preferably at least one compound selected from the group consisting of InP, ZnS and ZnSe, and more preferably includes InP. The proportion of InP included is 50% by mass or more and 100% by mass or less of the total mass of the core, preferably 60% by mass or more and 99% by mass or less, and more preferably 82% by mass or more and 95% by mass or less. In addition, the proportion of ZnS and/or ZnSe included is 0% by mass or more and 50% by mass or less of the total mass of the core, preferably 1% by mass or more and 40% by mass or less, and more preferably 5% by mass or more and 18% by mass or less.

In a multilayer shell structure, a material for the first shell is preferably one or more selected from ZnS, ZnSe and ZnSSe. The proportion of one or more selected from ZnS, ZnSe and ZnSSe included is for example 50% by mass or more and 100% by mass or less, preferably 75% by mass or more and 98% by mass or less, and more preferably 80% by mass or more and 97% by mass or less based on the total mass of the first shell. When a material for the first shell is a mixture of ZnS and ZnSe, the mixing ratio (mass ratio) is not particularly limited, and is 1/99 or more and 99/1 or less, and preferably 10/90 or more and 90/10 or less.

In a multilayer shell structure, the second shell is grown on the surface of the first shell. A material for the second shell is preferably equivalent to the material for the first shell. However, differences in the lattice constant with respect to the core differ from each material. That is, a case where 99% or more in the materials have the same quality is excluded. The proportion of one or more selected from ZnS, ZnSe and ZnSSe included is for example 50% by mass or more and 100% by mass or less, preferably 75% by mass or more and 98% by mass or less and more preferably 80% by mass or more and 97% by mass or less based on the total mass of the second shell. When a material for the second shell is a mixture of two selected from ZnS, ZnSe and ZnSSe, the mixing ratio (mass ratio) is not particularly limited, and is 1/99 or more and 99/1 or less, and 10/90 or more and 90/10 or less.

The first shell and the second shell in a multilayer shell structure have different lattice constants. A difference in the lattice constant between the core and the first shell for example is 2% or more and 8% or less, preferably 2% or more and 6% or less, and more preferably 3% or more and 5% or less. In addition, a difference in the lattice constant between the core and the second shell is 5% or more and 13% or less, preferably 5% or more and 12% or less, more preferably 7% or more and 10% or less, and further preferably 8% or more and 10% or less.

In addition, a difference in the lattice constant between the first shell and the second shell is for example 3% or more and 9% or less, preferably 3% or more and 7% or less, and more preferably 4% or more and 6% or less.

The quantum dots (A) by these core-multilayer shell structures can have an emission wavelength in a range of 400 nm or longer and 800 nm or shorter. The range of the emission wavelength is preferably 470 nm or longer and 650 nm or shorter, and particularly preferably 540 nm or higher and 580 nm or shorter.

Examples of the quantum dots (A) by these core-multilayer shell structures include InP/ZnS/ZnSe and InP/ZnSe/ZnS.

In addition, the quantum dots (A) may be surface-modified. Examples thereof include phosphorus compounds such as phosphine, phosphine oxide and trialkylphosphines; organic nitrogen compounds such as pyridine, aminoalkanes and tertiary amines; organic sulfur compounds such as mercaptoalcohol, thiol, dialkyl sulfides and dialkyl sulfoxides; higher fatty acids; and surface modifying agents (organic ligands) such as alcohols.

Two or more of the above quantum dots (A) may be used in combination. Quantum dots (A) of the core-(multilayer) shell type and quantum dots (A) of the homogeneous structure type may be used in combination.

The average particle diameter of the quantum dots (A) is not particularly limited as long as the particles can function as quantum dots. The average diameter of the quantum dots (A) is preferably 0.5 nm or more and 20 nm or less, more preferably 1.0 nm or more and 15 nm or less, and further preferably 2 nm or more and 7 nm or less. In quantum dots (A) of the core-(multilayer) shell type, the size of core is for example 0.5 nm or more and 10 nm or less, and preferably 2 nm or more and 5 nm or less. The average thickness of the shell is preferably 0.4 nm or more and 2 nm or less, and more preferably 0.4 nm or more and 1.4 nm or less. When the shell includes the first shell and the second shell, the average thickness of the first shell is for example 0.2 nm or more and 1 nm or less, and preferably 0.2 nm or more and 0.7 nm or less. The average thickness of the second shell does not depend on the average thickness of the first shell, and is for example 0.2 nm or more and 1 nm or less, and preferably 0.2 nm or more and 0.7 nm or less.

The quantum dots (A) having an average particle diameter within such range show a quantum-confined effect and function well as quantum dots, and moreover are easily prepared and have stable fluorescence characteristics. It should be noted that the average particle diameter of quantum dots (A) can be defined by, for example, applying a dispersion of the quantum dots (A) onto a substrate and drying the composition, removing a volatile component from a coating film and then observing the surface of the coating film with a transmission electron microscope (TEM). Typically, this average particle diameter can be defined as the number average diameter of circle equivalent diameters of particles obtained by image analysis of the TEM image.

The shape of quantum dots (A) is not particularly limited. Examples of the shape of quantum dots (A) include a spherical shape, a spheroid shape, a cylindrical shape, a polygonal shape, a disk shape, a polyhedral shape and the like. Among these, a spherical shape is preferred from the viewpoint of handleability and availability.

Because the characteristics as an optical film and wavelength conversion characteristics are good, the quantum dots (A) preferably include one or more selected from the group consisting of a compound (A1) having a fluorescence maximum in a wavelength range of 500 nm or higher and 600 nm or lower, and a compound (A2) having a fluorescence maximum in a wavelength range of 600 nm or higher and 700 nm or lower, and more preferably consists of one or more selected from the group consisting of the compound (A1) and the compound (A2).

A method for producing the quantum dots (A) is not particularly limited. Quantum dots produced by various well-known methods can be used as the quantum dots (A). As the method for producing the quantum dots (A), for example, a method in which an organometallic compound is thermally decomposed in a coordinating organic solvent can be used. In addition, the quantum dots (A) of the core-shell structure type can be produced by a method in which homogeneous cores are formed by reaction and then a shell layer precursor is allowed to react in the presence of dispersed cores to form a shell layer. In addition, for example, the quantum dots (A) having the above core-multilayer shell structure can be produced by the method described in WO 2013/127662. It should be noted that various commercially available quantum dots (A) can also be used.

### <Dispersion Medium (B)>

The dispersion medium (B) is a dispersion medium contained in the dispersion obtained by the method described above for producing the quantum dot dispersion. The dispersion medium (B) includes an organic solvent (B1) comprising a chalcogen element. The chalcogen elements are as described for chalcogenides with respect to quantum dots (A).

### (Organic Solvent (B1))

The organic solvent (B1) is an organic compound comprising a chalcogen element. Examples of the compound comprising the chalcogen element include a sulfur-containing compound, a selenium-containing compound and a tellurium-containing compound. Among these, the sulfur-containing compound and the selenium-containing compound are preferable, and the sulfur-containing compound is more preferable from the viewpoints of easy availability and low cost.

When the organic solvent (B1) is present as an organic solvent (B1) with a relatively low molecular weight, the organic solvent (B1) is more likely to exert the desired effect on the quantum dots (A). For this reason, it is preferable that the quantum dot dispersion or the composition for producing the film prepared by using the quantum dot dispersion does not contain compounds that can polymerize with the organic solvent (B1) by condensation, addition, or cross-linking reactions. The quantum dot dispersion, which do not contain compounds that can polymerize with organic solvents (B1), also have excellent stability during storage.

For example, the sulfur-containing compound such as a thiol compound, a sulfide compound, a disulfide compound, a thiophene compound, a sulfoxide compound, a sulfone compound, a thioketone compound, a sulfonic acid compound, a sulfonic acid ester compound, a sulfonic acid amide compound, and the like can be used as the sulfur-containing compound which is the organic solvent (B1). In view of excellent affinity for the surface of the quantum dots (A) and easily obtaining desired effect of using an organic solvent (B1), among the sulfur-containing compounds described above, the thiol compound, the sulfide compound, and the disulfide compound are preferred.

For example, a selenol compound, a selenide compound, a diselenide compound, a selenoxide compound, a selenone compound and the like can be used as the selenium-containing compound as the organic solvent (B1). In view of excellent affinity for the surface of the quantum dots (A) and easily obtaining desired effect of using an organic solvent (B1), among the selenium-containing compounds described above, the selenol compound, the selenide compound, and the diselenide compound are preferred.

For example, a tellurol compound, a telluride compound, and a ditelluride compound can be used as the tellurium-containing compound as the organic solvent (B1).

Specific examples of the sulfur-containing compound as the organic solvent (B1) will now be described.

For example, suitable thiol compounds as the organic solvent (B1) are exemplified by compounds represented by the following formula (b1).

R^{b1}—SH (b1)

In the formula (b1), R^{b1} represents an optionally substituted monovalent hydrocarbon group.

Suitable examples of the monovalent hydrocarbon group as R^{b1} include an optionally substituted alkyl group, an optionally substituted cycloalkyl group, an optionally substituted alkenyl group, an optionally substituted aryl group, an optionally substituted aralkyl group, and an optionally substituted alkylaryl group. The number of carbon atoms in the optionally substituted alkyl group is preferably 1 or more and 20 or less, more preferably 1 or more and 10 or less, and further preferably 1 or more and 6 or less. The number of carbon atoms in the optionally substituted cycloalkyl group is preferably 3 or more and 20 or less, more preferably 3 or more and 10 or less, and further preferably 3 or more and 8 or less. The number of carbon atoms in the optionally substituted alkenyl group is preferably 2 or more and 20 or less, more preferably 2 or more and 10 or less, and further preferably 2 or more and 6 or less. The number of carbon atoms in the optionally substituted aryl group is preferably 6 or more and 20 or less, more preferably 6 or more and 10 or less, and further preferably 6 or more and 8 or less. The number of carbon atoms in the optionally substituted aralkyl group is preferably 7 or more and 20 or less, more preferably 7 or more and 12 or less, and further preferably 7 or 8. The number of carbon atoms in the optionally substituted alkylaryl group is preferably 7 or more and 20 or less, more preferably 7 or more and 12 or less, and further preferably 7 or 8. Examples of optional substituents on these hydrocarbon groups include hydroxy group, thiol group, carboxy group, halogen atom, amino group, and the like. The number of substituents on the hydrocarbon group may be 2 or more.

Specific examples of thiol compounds include aliphatic thiol compounds such as thioglycerol, 2-mercaptoethanol, thioglycolic acid, 2,3-dimercapto-1-propanol, 1-propanethiol, 2-propanethiol, 2-methyl-2-propanethiol, 1,2-ethanedithiol, cyclohexanethiol, and 1-octanethiol, and aromatic thiol compounds such as thiophenol, p-toluenethiol, and aminobenzenethiol, and the like.

Suitable sulfide compounds as the organic solvent (B1) are exemplified by compounds represented by the following formula (s02).

R^{b2}—S—R^{b2} (b2)

In the formula (b2), R^{b2} represents an optionally substituted monovalent hydrocarbon group. Specific examples of sulfide compounds include dimethylsulfide, diethylsulfide, di-n-propylsulfide, ethylmethylsulfide, thioanisole, ethylthiobenzene, diphenylsulfide, dibenzylsulfide, and the like.

Suitable disulfide compounds as the organic solvent (B1) are exemplified by compounds represented by the following formula (b3).

R^{b3}—S—S—R^{b3} (b3)

In the formula (b3), R^{b3} represents an optionally substituted monovalent hydrocarbon group. Suitable examples of the monovalent hydrocarbon group as R^{b3} are same as suitable examples of the monovalent hydrocarbon group as R^{b1}. Specific examples of disulfide compounds include dialkyldisulfides having linear or branched alkyl groups having 1 or more and 10 or less carbon atoms. Such dialkyl disulfides include dimethyldisulfide, diethyldisulfide, di-n-propyl disulfide, diisopropyldisulfide, di-n-butyldisulfide, di-n-pentyldisulfide, and di-n-hexyl disulfide. Suitable examples of disulfide compounds other than those described above include diallyldisulfide, cyclohexyldisulfide, diphenyldisulfide, dibenzyldisulfide, di(p-tolyl)disulfide, 4,4′-dichlorodiphenyldisulfide, di(3,4-dichlorophenyl)disulfide, 2,2′-dithiobis(5-chloroaniline), di(2,4-xylyl)disulfide, and di(2,4-dichlorophenyl)disulfide, dichlorodiphenyldisulfide, di(3,4-dichlorophenyl)disulfide, 2,2′-dithiobis(5-chloroaniline), di(2,4-xylyl) disulfide, di(2,3-xylyl)disulfide, di(3,5-xylyl)disulfide, 2,4-xylyl-2,6-xylyldisulfide, 2,2′-dithiosalicylic acid, and 2,2′-dithiobis(4-tert-butylphenol).

For example, an ester compound in which an aliphatic polyhydric alcohol and an aliphatic carboxylic acid having a mercapto group and/or a selenol group is preferred as the organic solvent (B1). Such compounds have an ester bond, a mercapto group, and/or a selenol group. Due to the presence of these bonds or functional groups, the organic solvent (B1) has excellent affinity for the surface of the quantum dot (A). Therefore, when the above ester compound is used as the organic solvent (B1), it is easy to obtain the desired effect of the organic solvent (B1).

Specific examples of the aliphatic polyhydric alcohol include ethyleneglycol, diethyleneglycol, triethyleneglycol, propyleneglycol, dipropyleneglycol, tripropyleneglycol, glycerin, trimethylolpropane, pentaerythritol, dipentaerythritol, sorbitol, mannitol, sorbitan, diglycerine, sucrose, glucose, mannose, fructose, methyl glucoside and the like.

Suitable examples of the aliphatic carboxylic acid include a thioglycolic acid and a 3-mercaptopropionic acid.

Preferable examples of ester compounds described above include ethyleneglycol di-3-mercaptopropionate, diethyleneglycol di-3-mercaptopropionate, propyleneglycol di-3-mercaptopropionate, dipropyleneglycol di-3-mercaptopropionate, glycerin tri-3-mercaptopropionate, trimethylolpropane tri-3-mercaptopropionate (TMMP) and pentaerythritol tetra-3-mercaptopropionate (PEMP).

The boiling point of the organic solvent (B1) described above under atmospheric pressure is preferably 60° C. or higher and 400° C. or lower, more preferably 80° C. or higher and 350° C. or lower, and further preferably 100° C. or more and 300° C. or less. When the organic solvent (B1) having a boiling point within such a range is used, it is easy to prepare the solid concentration of the quantum dot dispersion by condensation, etc., or to remove the organic solvent (B1) when a film is produced by using the composition for producing film prepared using the quantum dot dispersion.

A content of the organic solvent (B1) in the quantum dot dispersion is not particularly limited as long as the desired effect is obtained. Amount of the organic solvent (B1) in the quantum dot dispersion is preferably 10 parts by mass or more and 2000 parts by mass or less, more preferably 10 parts by mass or more and 1500 parts by mass or less, further preferably 30 parts by mass or more and 1200 parts by mass or less, and especially preferably 50 parts by mass or more and 1000 parts by mass or less relative to 100 parts by mass of the quantum dots (A). In addition, the ratio of the sum of the mass of the organic solvent (B1) and the mass of the quantum dots (A) to the total mass of the dispersion medium (B) is preferably 93% by mass or more, more preferably 95% by mass or more, from the view point of easily obtaining the desired effect of using the organic solvent (B1). Upper limit may be 100% by mass. For example, upper limit is 99% by mass or less.

The ratio of the mass of the organic solvent (B1) to the total mass of the dispersion medium (B) is not particularly limited. The ratio of the mass of the organic solvent (B1) to the total mass of the dispersion medium (B) is preferably 50% by mass or more, more preferably 70% by mass or more, further preferably 80% by mass or more, particularly preferably 90% by mass or more, and most preferably 100% by mass, from the view point of easily obtaining the desired effect of using the organic solvent (B1). In addition, ratio of the mass of the organic solvent (B1) to the total mass of the quantum dot dispersion is preferably 50% by mass or more, more preferably 70% by mass or more, and further preferably 80% by mass or more, from the view point of easily obtaining the desired effect of using the organic solvent (B1). Ratio of the mass of the organic solvent (B1) to the total mass of the quantum dot dispersion may be 90% by mass or more, or 95% by mass or more.

### (Organic Solvent (B2))

The dispersion medium (B) may include an organic solvent (B2), which is a solvent other than organic solvent (B1), along with the above organic solvent (B1) as long as it does not interfere with the purpose of the invention.

From the viewpoint of promotion and stabilization of dispersion of the quantum dots (A), an organic solvent (B2a) which is a compound having a cyclic skeleton and including a heteroatom other than a hydrogen atom, a carbon atom, and an atom of the chalcogen element is preferable as the organic solvent (B2). The organic solvent (B2a) including a heteroatom is not a hydrocarbon solvent as described above. Examples of heteroatoms which can be included in the organic solvent (S2a) include N, O, P and the like.

It is unclear why the use of the organic solvent (B2a) is effective in promoting and stabilizing the dispersion of quantum dots (A). For example, it is assumed that a cyclic skeleton of the organic solvent (B2a) has the effect of inhibiting the aggregation of quantum dots (A).

As for a cyclic skeleton of the organic solvent (B2a), an alicyclic skeleton is preferred. Herein, a cyclic skeleton which exhibits no aromaticity is deemed as an alicyclic skeleton. In addition, in the case in which the organic solvent (B2a) has both an aromatic ring skeleton and an alicyclic skeleton like a tetralin ring, the solvent (B2a) is deemed as having an alicyclic skeleton. It is inferred that greater bulkiness of the alicyclic skeleton to some extent than the aromatic ring skeleton, which has a planar steric structure, favorably contributes to promoting dispersion of the quantum dots (A) and the stabilization of the dispersion, although the reasons therefor are unclear.

The organic solvent (B2a) preferably has at least one type of bond selected from the group consisting of an ester bond (—CO—O—), an amide bond (—CO—NH—), a carbonate bond (—O—CO—O—), a ureido bond (—NH—CO—NH—), and a urethane bond (—O—CO—NH—). In the present description, when the ester bond and the amide bond are simply referred to, the ester bond and the amide bond respectively mean a “carboxylic acid ester bond” and a “carboxylic acid amide bond”. In the amide bond, the ureido bond, and the urethane bond, an organic group may be bonded to a nitrogen atom. The type of the organic group is not particularly limited. The organic group is preferably an alkyl group, more preferably an alkyl group having 1 or more and 6 or less carbon atoms, and further preferably a methyl group or an ethyl group. In addition, in the case in which the organic solvent (B2a) includes any of these bonds, resin components and/or monomer components are likely to be favorably dissolved in the composition for producing the film containing various resin components and/or monomer components.

Preferred examples of the organic solvent (B2a) include: aromatic solvents such as anisole, phenetole, propyl phenyl ether, butyl phenyl ether, cresyl methyl ether, ethyl benzyl ether, diphenyl ether, dibenzyl ether, acetophenone, propiophenone, benzophenone, pyridine, pyrimidine, pyrazine, and pyridazine; alicyclic alcohols such as cyclopentanol, cyclohexanol, 1,4-cyclohexanediol, 1,3-cyclohexanediol, 1,4-cyclohexanedimethanol, and 1,3-cyclohexanedimethanol; alicyclic ethers such as cyclohexyl methyl ether, cyclohexyl ethyl ether, tetrahydrofuran, tetrahydropyran, and dioxane; alicyclic ketones such as cyclopentanone, cyclohexanone, cycloheptanone, 2-methylcyclohexanone, 1,4-cyclopentanedione, and 1,3-cyclopentanedione; lactones such as β-propiolactone, γ-butyrolactone, β-methyl-γ-butyrolactone, δ-valerolactone, ε-valerolactone, ε-caprolactone, α-methyl-ε-caprolactone, and ε-methyl-ε-caprolactone; cyclic amides or cyclic ureas such as N-methyl-2-pyrrolidone, N-ethyl-2-pyrrolidone, 1,3-dimethyl-2-imidazolidinone, and N,N-dimethylpropyleneurea; cyclic carbonate such as ethylene carbonate, and propylene carbonate; and the like.

In addition, as the solvent (B2a), a cycloalkyl ester of carboxylic acid is preferable. The cycloalkyl ester of carboxylic acid is preferably a cycloalkyl ester of carboxylic acid represented by the following formula (s1):

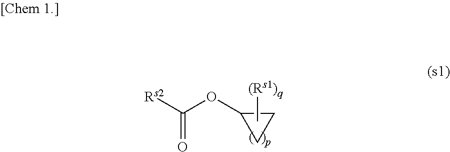

in which in the formula (S1), R^{s1} represents an alkyl group having 1 or more and 3 or less carbon atoms; R^{s2} represents an alkyl group having 1 or more and 6 or less carbon atoms; p is an integer of 1 or more and 6 or less; and q is an integer of 0 or more and (p+1) or less.

R^{s1} in the formula (s1) is exemplified by a methyl group, an ethyl group, an n-propyl group, and an isopropyl group, and is preferably a methyl group. R^{s2} in the formula (s1) is exemplified by a methyl group, an ethyl group, an n-propyl group, an isopropyl group, an n-butyl group, an isobutyl group, a sec-butyl group, a tert-butyl group, an n-pentyl group, and an n-hexyl group. As the alkyl group represented by R^{s2}, a methyl group, an ethyl group, an n-propyl group, an isopropyl group, and an n-butyl group, are preferable, and a methyl group and an ethyl group are more preferable.

Preferred examples of the carboxylic acid cycloalkyl ester represented by the formula (s1) include cyclopropyl acetate, cyclobutyl acetate, cyclopentyl acetate, cyclohexyl acetate, cycloheptyl acetate, cyclooctyl acetate, cyclopropyl propionate, cyclobutyl propionate, cyclopentyl propionate, cyclohexyl propionate, cycloheptyl propionate, and cyclooctyl propionate. Among these, cyclopentyl acetate and cyclohexyl acetate are preferable, since they are readily available and have a preferable boiling point.

Among the organic solvents (B2a) described above, the carboxylic acid cycloalkyl ester represented by the formula (s1) is preferable, and cyclopentyl acetate and cyclohexyl acetate are particularly preferable.

Examples of the organic solvent (B2) other than examples of the organic solvent (B2a) include: alcohols such as methanol, ethanol, propanol and n-butanol; polyhydric alcohols such as ethylene glycol, diethylene glycol, propylene glycol and dipropylene glycol; ketones such as acetone, methyl ethyl ketone, methyl n-amyl ketone, methyl isoamyl ketone and 2-heptanone; compounds having an ester bond such as ethylene glycol monoacetate, diethylene glycol monoacetate, propylene glycol monoacetate, or dipropylene glycol monoacetate; ether derivatives such as monomethyl ethers, monoethyl ethers, monopropyl ethers, monobutyl ethers, monophenyl ethers or the like of the polyhydric alcohols or the compounds having an ester bond; esters such as methyl lactate, ethyl lactate, methyl acetate, ethyl acetate, butyl acetate, methyl pyruvate, ethyl pyruvate, methyl methoxypropionate and ethyl ethoxypropionate; aliphatic hydrocarbon organic solvents such as pentane, hexane, heptane and octane; aromatic organic solvents such as ethylbenzene, diethylbenzene, amylbenzene, isopropylbenzene, toluene, xylene, cymene and mesitylene; nitrogen-containing organic solvents such as N,N,N′,N′-tetramethylurea, N,N,2-trimethylpropionamide, N,N-dimethylacetamide, N,N-dimethylformamide, N,N-diethylacetamide, N,N-diethylformamide and N-ethylpyrrolidone.

Amount of the dispersion medium (B) is not particularly limited as long as sufficient amount of the organic solvent (B1) to obtain desired effect is included in the dispersion medium (B). Amount of the dispersion medium (B) is preferably an amount in which the concentration of quantum dots (A) in the quantum dot dispersion is 0.1% by mass or more and 70% by mass or less, more preferably an amount of 1% by mass or more and 60% by mass or less, and further preferably an amount of 5% by mass or more and 50% by mass or less.

### <Other Component>

The quantum dot dispersion may include other component than the quantum dots (A), and the dispersion medium (B), as long as the objects of the present invention are not inhibited. Other component is exemplified by a silane coupling agent, an adhesion enhancer, a dispersant, a surfactant, an ultraviolet ray-absorbing agent, an antioxidant, an antifoaming agent, a viscosity modifier, a resin, rubber particles, a colorant, and the like. Moreover, in the case in which the liquid composition includes the rubber particles, elasticity is imparted to the formed quantum dot-containing film, and thereby the brittleness of the quantum dot-containing film is likely to be eliminated.

In view of promoting and stabilizing dispersion of quantum dots (A), the quantum dot dispersion preferably includes an ionic liquid (I). When the quantum dot dispersion includes the ionic liquid (I), the quantum dot dispersion preferably includes the ionic liquid (I) in combination with the organic solvent (B2a) described above. When the quantum dot dispersion includes the ionic liquid (I) in combination with the organic solvent (B2a), effects of promoting and stabilizing dispersion of quantum dots (A) are more easily enhanced.

As the ionic liquid (I), ionic liquids that are used in the field of organic synthesis and in electrolytes for batteries etc. can be used without any particular limitation. The ionic liquid (I) is typically a salt capable of being molten in a temperature region of 140° C. or lower, and is preferably a stable salt that is liquid at 140° C. or lower.

The melting point of the ionic liquid (I) is preferably 120° C. or lower, more preferably 100° C. or lower, and even more preferably 80° C. or lower from the viewpoint of, for example, more reliable achievement of desired effects of and the handleability of the ionic liquid (I) and the quantum dot dispersion.

The ionic liquid (I) is preferably composed of an organic cation and an anion. The ionic liquid (I) is preferably composed of a nitrogen-containing organic cation, a phosphorus-containing organic cation, or a sulfur-containing organic cation, and a counteranion, and more preferably of a nitrogen-containing organic cation or a phosphorus-containing organic cation, and a counteranion.

As the organic cation constituting the ionic liquid (I), at least one selected from the group consisting of an alkyl chain quaternary ammonium cation, a piperidinium cation, a pyrimidinium cation, a pyrrolidinium cation, an imidazolium cation, a pyridinium cation, a pyrazolium cation, a guanidinium cation, a morpholinium cation, a phosphonium cation and a sulfonium cation is preferable, and an alkyl chain quaternary ammonium cation, a piperidinium cation, a pyrrolidinium cation, an imidazolium cation, a morpholinium cation, or a phosphonium cation is more preferable in light of e.g. their favorable affinity for the dispersion medium (B), and a pyrrolidinium cation, an imidazolium cation, or a phosphonium cation is even more preferable from the viewpoint that the effects of the invention are particularly likely to be achieved.

Specific examples of the alkyl chain quaternary ammonium cation include a quaternary ammonium cation represented by the following formula (L1). More specifically, the alkyl chain quaternary ammonium cation is exemplified by, for example, a tetramethylammonium cation, an ethyltrimethylammonium cation, a diethyldimethylammonium cation, a triethylmethylammonium cation, a tetraethylammonium cation, a methyltributylammonium cation, an octyltrimethylammonium cation, a hexyltrimethylammonium cation, a methyltrioctylammonium cation, and the like. Specific examples of the piperidinium cation include a piperidinium cation represented by the following formula (L2). More specifically, the piperidinium cation is exemplified by, for example, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, and the like. Specific examples of the pyrimidinium cation include a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, a 1,2,3,4-tetramethyl-1,6-dihydropyrimidinium cation, and the like.

Specific examples of the pyrrolidinium cation include a pyrrolidinium cation represented by the following formula (L3), and more specifically, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, and the like. Specific examples of the imidazolium cation include an imidazolium cation represented by the following formula (L5), and more specifically, a 1,3-dimethylimidazolium cation, a 1,3-diethylimidazolium cation, a 1-ethyl-3-methylimidazolium cation, a 1-propyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, and the like. Specific examples of the pyridinium cation include a pyridinium cation represented by the following formula (L6), and more specifically, a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, and the like.

Specific examples of the pyrazolium cation include a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, a 1,2,3,4-tetramethyl-1,6-dihydropyrimidinium cation, and the like.

Specific examples of the phosphonium cation include a phosphonium cation represented by the following formula (L4). More specifically, the phosphonium cation is exemplified by tetraalkylphosphonium cations such as a tetrabutylphosphonium cation, a tributylmethylphosphonium cation, and a tributylhexylphosphonium cation, and a triethyl(methoxymethyl)phosphonium cation, and the like. Specific examples of the sulfonium cation include a triethylsulfonium cation, a dimethylethylsulfonium cation, a triethylsulfonium cation, an ethylmethylpropylsulfonium cation, a butyldimethylsulfonium cation, a 1-methyltetrahydrothiophenium cation, a 1-ethyltetrahydrothiophenium cation, a 1-propyltetrahydrothiophenium cation, a 1-butyltetrahydrothiophenium cation, or a 1-methyl-[1,4]-thioxonium cation, and the like. Among these, as the sulfonium cation, a sulfonium cation having a cyclic structure such as a tetrahydrothiophenium-based or hexahydrothiopyrylium-based 5-membered ring or 6-membered ring is preferable, and the sulfonium cation may have a heteroatom such as an oxygen atom in the cyclic structure.

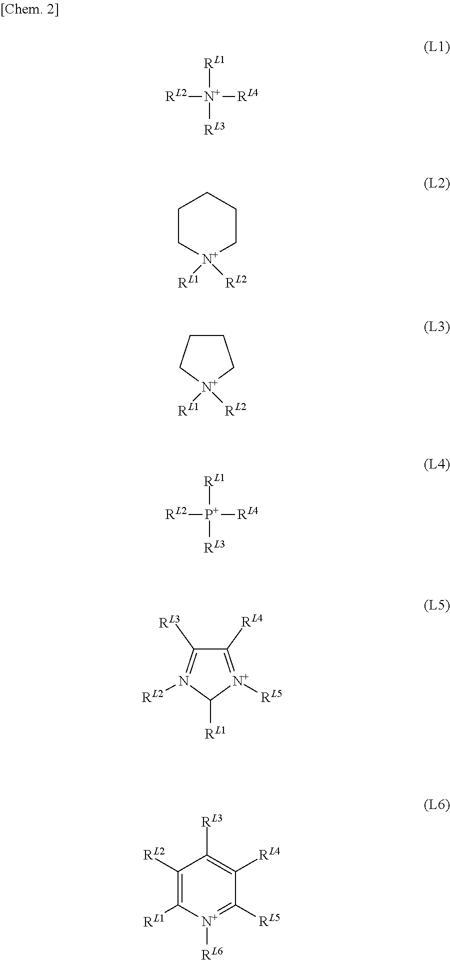

In the formulas (L1) to (L4), R^{L1} to R^{L4} each independently represent an alkyl group having 1 or more and 20 or less carbon atoms, or an alkoxyalkyl group represented by R^{L7}—O—(CH₂)— (wherein, R^{L7} represents a methyl group or an ethyl group, and Ln is an integer of 1 or more and 4 or less). In the formula (L5), R^{L1} to R^{L4} each independently represent an alkyl group having 1 or more and 20 or less carbon atoms, an alkoxyalkyl group represented by R^{L7}—O—(CH₂)_{Ln}— (wherein, R^{L7} represents a methyl group or an ethyl group, and Ln is an integer of 1 or more and 4 or less), or a hydrogen atom. In the formula (L6), R^{L1} to R^{L6} each independently represent an alkyl group having 1 or more and 20 or less carbon atoms, an alkoxyalkyl group represented by R^{L7}—O—(CH₂)_{Ln}— (wherein, R^{L7} represents a methyl group or an ethyl group, and Ln is an integer of 1 or more and 4 or less), or a hydrogen atom.

The anion constituting the ionic liquid (I) may be an organic anion or an inorganic anion. Since the ionic liquid (I) has good affinity for the dispersion medium (B), the organic anion is preferred. The organic anion is preferably at least one selected from the group consisting of a carboxylic acid-based anion, an N-acylamino acid ion, an acidic amino acid anion, a neutral amino acid anion, an alkyl sulfuric acid-based anion, a fluorine-containing compound-based anion and a phenol-based anion, more preferably a carboxylic acid-based anion or an N-acylamino acid ion.

Specific examples of the carboxylic acid-based anion include an acetate ion, a decanoate ion, a 2-pyrrolidone-5-carboxylate ion, a formate ion, an α-lipoate ion, a lactate ion, a tartarate ion, a hippurate ion, an N-methylhippurate ion, and the like. Among these, an acetate ion, a 2-pyrrolidone-5-carboxylate ion, a formate ion, a lactate ion, a tartarate ion, a hippurate ion and an N-methylhippurate ion are preferable, and an acetate ion, an N-methylhippurate ion and a formate ion are more preferable. Specific examples of the N-acylamino acid ion include an N-benzoylalanine ion, an N-acetylphenylalanine ion, an aspartate ion, a glycine ion, an N-acetylglycine ion, and the like, and among these, an N-benzoylalanine ion, an N-acetylphenylalanine ion and an N-acetylglycine ion are preferable, and an N-acetylglycine ion is more preferable.

Specific examples of the acidic amino acid anion include an aspartate ion, a glutamate ion, and the like, and specific examples of the neutral amino acid anion include a glycine ion, an alanine ion, a phenylalanine ion, and the like. Specific examples of the alkyl sulfuric acid-based anion include a methanesulfonate ion, and the like. Specific examples of the fluorine-containing compound-based anion include a trifluoromethanesulfonate ion, a hexafluorophosphonate ion, a trifluorotris(pentafluoroethyl)phosphonate ion, a bis(fluoroalkylsulfonyl)imide ion (for example, a bis(trifluoromethanesulfonyl)imide ion), a trifluoroacetate ion, a tetrafluoroborate ion, and the like. Specific examples of the phenol-based anion include a phenol ion, a 2-methoxyphenol ion, a 2,6-di-tert-butylphenol ion, and the like.

In view of achieving the effects of the invention more reliably, above inorganic anion is preferably at least one selected form the group consisting of F⁻, Cl⁻, Br⁻, I⁻, BF₄⁻, PF₆⁻, and N(SO₂F)₂⁻, more preferably BF₄⁻, PF₆⁻, or N(SO₂F)₂⁻, and further preferably BF₄⁻ or PF₆⁻.

The ionic liquid (I) can be produced by, for example, a procedure disclosed in paragraph 0045 of PCT International Publication No. 2014/178254, etc. The ionic liquid (I) can be used individually or two or more ionic liquids (I) can be used in combination. The content of the ionic liquid (I) relative to 100 parts by mass of the quantum dots (A) is preferably 10 parts by mass or more and 500 parts by mass or less, more preferably 90 parts by mass or more and 400 parts by mass or less, and even more preferably 100 parts by mass or more and 300 parts by mass or less from the viewpoint of a favorable effect of dispersion of the quantum dots (A) in the quantum dot dispersion.

### <Dispersing Method>

Method for producing the quantum dot dispersion includes dispersing the quantum dots (A) in the dispersing medium (B). A method for dispersing the quantum dots (A) in the dispersing medium (B) is not particularly limited. For example, the method for dispersing the quantum dots (A) in the dispersion medium (B) may be a method of dispersing solid quantum dots (A) produced by a well-known method into the dispersion medium (B).

Preferred example of a method for dispersing the quantum dots (A) in the dispersion medium (B) include a method including:

preparing a preliminary dispersion containing the quantum dots (A) and a preliminary dispersion medium (pB); and
replacing the preliminary dispersion medium (pB) contained in the preliminary dispersion with the dispersion medium (B).

Here, the preliminary dispersion is a preliminary dispersion used to prepare the quantum dot dispersion containing the quantum dots (A) and dispersion medium (B). Method for preparing the preliminary dispersion is not particularly limited. Commercially available quantum dot dispersion can be used as the preliminary dispersion. In addition, the preliminary dispersion can also be prepared by removing the preliminary dispersion (pB) from the commercially available quantum dot dispersion by volatilizing or other method, and then adding the dispersion medium (B) to the residue containing the quantum dots (A) to disperse the quantum dots (A).

As the preliminary dispersion medium (pB), the same type of solvent as the other solvents (B2) other than the organic solvent (B1), described for solvent (S), can be used.

Concentration of the quantum dots (A) in the preliminary dispersion is not particularly limited. Concentration of the quantum dots (A) in the preliminary dispersion is same as the concentration of the quantum dots (A) in the quantum dot dispersion produced by the method described above.

Examples of preferred method to replace the preliminary dispersion medium (pB) in the preliminary dispersion with the dispersion medium (B) includes a method including:

removing at least a part of the preliminary dispersion medium (pB) from the preliminary dispersion, and
adding the dispersion medium (B) to the mixture containing the quantum dots (A) and the remaining preliminary dispersion medium (pB), or quantum dots (A) after removal of the preliminary dispersion medium (pB).

Method of removing at least a part of the preliminary dispersion medium (pB) is not particularly limited. An example of such a method is to volatilize the preliminary dispersion medium (pB). Method of volatilizing the preliminary dispersion medium (pB) is not particularly limited. For example, volatilizing the preliminary dispersion medium (pB) is conducted by heating under atmospheric pressure or reduced pressure. For example, the preliminary dispersion medium (pB) may be removed, by a method in which the quantum dots (A) are allowed to settle in the vessel by means of centrifugal sinking or other methods, and then the preliminary dispersion medium (pB) is removed as supernatant.

Since it may be difficult to settle quantum dots (A) depending on the material and particle size of the quantum dots (A), as a method of removing at least a part of the preliminary dispersion medium (pB), removing the preliminary dispersion medium by volatilizing the preliminary dispersion medium (pB) is preferred.

When at least a part of the preliminary dispersion medium pB) is removed, an amount of the removed preliminary dispersion medium (pB) is not particularly limited as long as it does not interfere with the purpose of the invention. Amount of the removed preliminary dispersion medium (pB) may be 50% by mass or more, 70% by mass or more, 90% by mass or more, or 100% of the mass of the preliminary dispersion medium (pB) before removal.

After at least a part of the preliminary dispersion medium (pB) is removed in this manner, the dispersion medium (B) is added to the residue, and then the quantum dots (A) are dispersed in the dispersion medium (B) to prepare a quantum dot dispersion. The amount of the dispersion medium (B) used is not particularly limited. As described above, amount of dispersion medium (B) used is an amount where the content of the organic solvent (B1) in the quantum dot dispersion is preferably 10 parts by mass or more and 2000 parts by mass or less, more preferably 10 parts by mass or more and 1500 parts by mass or less, even more preferably 30 parts by mass or more and 1200 parts by mass or less, and especially preferably 50 parts by mass or more and 1000 parts by mass or less relative to 100 parts by mass of the quantum dot (A).

Above method for replacing preferably include:

preparing a liquid including the quantum dots (A), the dispersion medium (B) and the preliminary dispersion medium (pB) by adding the dispersion medium to the preliminary dispersion, and
removing the preliminary dispersion medium (pB) from the liquid including the quantum dots (A), the dispersion medium (B), and the preliminary dispersion medium (pB). According to this method, the preliminary dispersion medium (pB) is replaced by the dispersion medium (B) because the preliminary dispersion medium (pB) is distilled off while the dispersion medium (B) is added.

Removal of the preliminary dispersion medium (pB) from the liquid including the quantum dots (A), the dispersion medium (B) and the preliminary dispersion medium (pB) may be removal of the preliminary dispersion medium (pB) alone or removal of the preliminary dispersion medium (pB) and the dispersion medium (B). Removal of the preliminary dispersion medium (pB) alone is generally difficult, and typically the preliminary dispersion medium (pB) is removed along with the dispersion medium (B). The removal of the preliminary dispersion medium (pB) may be conducted in any way as long as the desired amount of the preliminary dispersion medium (pB) can be removed. In terms of preventing an excessive decrease in the amount of dispersion medium (B), it is preferable that the removal of the preliminary dispersion medium (pB) is carried out under conditions where the amount of preliminary dispersion medium (pB) removed is greater than the amount of dispersion medium (B) removed.

For example, when the boiling point of the preliminary dispersion medium (pB) is lower than the boiling point of the dispersion medium (B), the preliminary dispersion medium (pB) can be preferentially removed by heating the liquid containing the quantum dots (A), the dispersion medium (B), and the preliminary dispersion medium (pB) at a temperature of the boiling point of the preliminary dispersion medium (pB) or higher and below the boiling point of the dispersion medium (B).

When the boiling point of the preliminary dispersion medium (pB) is higher than that of the dispersion medium (B), the vapor generated by heating the liquid including the quantum dots (A), the dispersion medium (B), and the preliminary dispersion medium (pB) is introduced into the condenser, and reflux is carried out by cooling in the condenser at a temperature at which the vapor of the preliminary dispersion medium (pB) is not sufficiently condensed while the vapor of the dispersion medium (B) condenses sufficiently. By doing so, the dispersion medium (B)-rich condensate can be refluxed into the liquid containing the quantum dots (A). Meanwhile, the preliminary dispersion medium (pB)-rich vapor is distilled off.

If the amount of the dispersion medium (B) that is distilled off along with the preliminary dispersion medium (pB) is too large, the above method may be carried out while adding dispersion medium (B) to the liquid containing the quantum dots (A).

Other methods other than those mentioned above for removing the preliminary dispersion medium (pB) from the liquid containing the quantum dots (A), the dispersion medium (B), and the preliminary dispersion medium (pB) include centrifugal separation, membrane separation methods using differences in molecular size, methods using differences in freezing point, freeze drying methods, and the like.

By the method described above, the quantum dot dispersion is obtained by removing the preliminary dispersion medium (pB) from the liquid containing the quantum dots (A), the dispersion medium (B), and the preliminary dispersion medium (pB). In this case, the amount of preliminary dispersion medium (pB) to be removed is not particularly limited, as long as the concentration of the quantum dots (A) in the quantum dot dispersion is within the desired range and the desired amount of organic solvent (B1) is present in the quantum dot dispersion. The amount of preliminary dispersion medium (pB) removed may be 50% by mass or more, 70% by mass or more, 90% by mass or more, or 100% of the mass of preliminary dispersion medium (pB) before removal.

In the method of producing the quantum dot dispersion described above, it is preferable that the quantum dots (A) are heated at 50° C. or higher and 300° C. or lower in the presence of organic solvent (B1) during or after the production of the quantum dot dispersion. The heating temperature is preferably 70° C. or higher and 270° C. or lower, and more preferably 100° C. or higher and 250° C. or lower. By doing so, it is easy to produce the quantum dot dispersion in which the quantum dots (A) are well dispersed.

### <<Quantum Dot Dispersion>>

The quantum dot dispersion is a quantum dot dispersion in which the quantum dots (A) is dispersed in the dispersion medium (B). The quantum dots (A) and the dispersion medium (B) are as described above.

A content of the organic solvent (B1) in the quantum dot dispersion is not particularly limited as long as the desired effect is obtained. Amount of the organic solvent (B1) in the quantum dot dispersion is preferably 10 parts by mass or more and 2000 parts by mass or less, more preferably 30 parts by mass or more and 1200 parts by mass or less, and further preferably 50 parts by mass or more and 1000 parts by mass or less relative to 100 parts by mass of the quantum dots (A).

The ratio of the mass of the organic solvent (B1) to the total mass of the dispersion medium (B) is not particularly limited. The ratio of the mass of the organic solvent (B1) to the total mass of the dispersion medium (B) is preferably 50% by mass or more, more preferably 70% by mass or more, further preferably 80% by mass or more, particularly preferably 90% by mass or more, and most preferably 100% by mass, from the viewpoint of easily obtaining the desired effect of using the organic solvent (B1). In addition, ratio of the mass of the organic solvent (B1) to the total mass of the quantum dot dispersion is preferably 50% by mass or more, more preferably 70% by mass or more, and further preferably 80% by mass or more, from the viewpoint of easily obtaining the desired effect of using the organic solvent (B1). Ratio of the mass of the organic solvent (B1) to the total mass of the quantum dot dispersion may be 90% by mass or more, or 95% by mass or more.

The above quantum dot dispersion is preferably blended into the coating liquid when preparing the coating liquid for producing a film containing quantum dots (A). Even if the quantum yield of the film containing quantum dots (A) prepared using the above coating liquid for producing the film containing the above quantum dot dispersion is reduced due to factors such as oxidation, the quantum yield can be recovered by heating the film in a non-oxidative atmosphere, as described above.

### EXAMPLES

Hereinafter, the present invention is described in more detail by way of Examples, but the present invention is not limited to these Examples.

In following examples, following PEMP and TMMP were used as the organic solvent (B1). Boiling points of PEMP and TMMP at atmospheric pressure are described below.

PEMP: Pentaerythritol tetra-3-mercaptopropionate (boiling point 250° C.)
TMMP: Trimethylolpropane tri-3-mercaptopropionate (boiling point 220° C.)

### Example 1

0.6 g of preliminary dispersion containing quantum dots (emission maximum 630 nm) in which ligands coordinated to particles with a core made of InP coated with a shell layer made of ZnS at a concentration of 20% by mass was added in a glass vessel. Under an inert gas atmosphere, preliminary dispersion was heated at 120° C. for 20 minutes to remove propylene glycol monomethyl ether acetate to obtain solid quantum dots in a glass vessel. To a glass vessel containing 0.12 g of solid quantum dots, 0.5 g of PEMP was added as organic solvent (B1), and the quantum dots were dispersed in the organic solvent (B1) to obtain a quantum dot dispersion.

### Example 2

0.5 g of preliminary dispersion containing quantum dots (emission maximum 630 nm) in which ligands coordinated to particles with a core made of InP coated with a shell layer made of ZnS at a concentration of 20% by mass was added in a glass vessel. Then, 0.5 g of PEMP was added as organic solvent (B1) in the glass vessel. Liquid in the glass vessel was heated at 200° C. for 1 hour to distill off propylene glycol monomethyl ether acetate to obtain quantum dot dispersion containing 0.12 g of quantum dots in 0.5 g of PEMP.

### Example 3

The quantum dot dispersion was obtained in the same manner as in Example 2, except that PEMP was changed to TMMP.

### Example 4

The quantum dot dispersion solution was obtained in the same manner as in Example 3, except that the quantum dots used in Example 3 were changed to quantum dots (emission maximum 620 nm) consisting of particles with a core made of InP coated with a shell layer made of ZnS and a ligand coordinated to the core.

### Example 5

The quantum dot dispersion solution was obtained in the same manner as in Example 3, except that the quantum dots used in Example 3 were changed to quantum dots (emission maximum 530 nm) consisting of particles with a core made of InP coated with a shell layer made of ZnS and a ligand coordinated to the core.

### Comparative Example 1

A dispersion of quantum dots (emission maximum of 630 nm) consisting of particles with a core made of InP coated with a shell layer made of ZnS and a ligand coordinated to the core in propylene glycol monomethyl ether acetate with a concentration of 20% by mass was used.

Using the quantum dot dispersions of the above Examples and a Comparative Example, quantum yield was evaluated according to following method. First, 0.6 g of the quantum dot dispersion of each Examples and a Comparative Example was mixed with 0.5 g of the negative type photosensitive composition to prepare photosensitive compositions for producing film containing quantum dots. Composition consisting of 35 parts by mass of alkali-soluble resin and 7 parts by mass of dipentaerythritol hexaacrylate as the base component, 4 parts by mass of photopolymerization initiator having following structure as the curing agent, 0.7 parts by mass of 3-methacryloxypropyltrimethoxysilane, and 54 parts by mass of propylene glycol monomethyl ether acetate as the solvent was used as negative type photosensitive composition. A resin consisting of the following constituent units was used as an alkali-soluble resin. The numerical character on the lower right of the parentheses in each constituent unit represents the molar ratio of constituent unit in the resin.

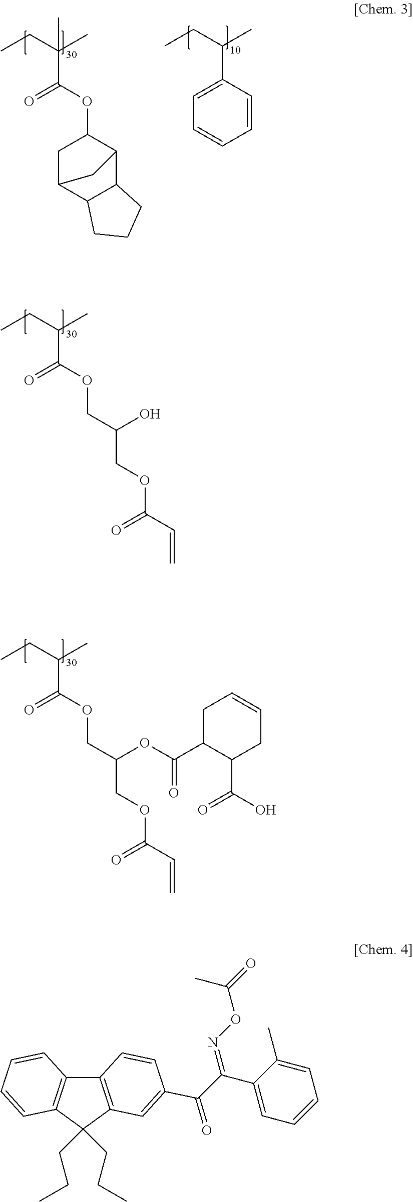

The obtained compositions for producing film were applied to glass substrates by spin-coating method to form coating films with a thickness of 5 μm. Quantum yields of the formed coating films were measured using Quantaurus-QY C11347 (Hamamatsu Photonics, Inc.). Quantum yields of films are noted as QY1 in Table 1. Then, the coating films were baked at 100° C. in air, and the entire surface of the coating films was exposed and cured at an exposure amount of 50 mJ/cm². Quantum yields of the obtained cured films were measured. Quantum yields of cured films are noted as QY2 in Table 1. Further, cured films were baked at 200° C. for 60 minutes under nitrogen atmosphere. Quantum yields of cured films baked were measured. Quantum yields of cured films after baking under nitrogen atmosphere is noted as QY3 in Table 1.

TABLE 1

| | | | | | | QY3 (%) |
|---|---|---|---|---|---|---|
| | Quantum dot | | Preparation | | | Cured film |
| | (Core/Shell/ | | method of | | | (After baking |
| | Emission | Organic | Quantum dot | QY1 (%) | QY2 (%) | under N₂ |
| | maximum) | solvent (B1) | dispersion | Coating film | Cured film | atmosphere) |
| Example 1 | InP/ZnS/ | PEMP | 1st: Drying | 71.7 | 65.5 | 66.4 |
| | 630 nm | | 2nd: Addition | | | |
| | | | of Organic | | | |
| | | | solvent (B1) | | | |
| Example 2 | InP/ZnS/ | PEMP | 1st: Addition | 70.5 | 65.3 | 68.0 |
| | 630 nm | | of Organic | | | |
| Example 3 | InP/ZnS/ | TMMP | solvent (B1) | 68.0 | 63.1 | 68.2 |
| | 630 nm | | 2nd: Distillation | | | |
| Example 4 | InP/ZnS/ | TMMP | of preliminary | 71.8 | 66.4 | 72.6 |
| | 620 nm | | dispersion | | | |
| Example 5 | InP/ZnS/ | TMMP | medium | 48.5 | 42.9 | 50.4 |
| | 530 nm | | | | | |
| Comparative | InP/ZnS/ | — | — | 58.0 | 44.0 | 41.0 |
| Example 1 | 630 nm | | | | | |

According to table 2, from comparison between QY1 and QY2, it is shown that quantum yield was lowered by baking and exposure in air. However, in all Examples where the quantum dot dispersions were prepared using organic solvents (B1) containing chalcogen elements, the quantum yield was recovered by baking the cured films under nitrogen atmosphere. On the other hand, in Comparative Example 1 on a quantum dot dispersion that do not contain the organic solvent (B1) containing chalcogen elements, quantum yield lowered by baking and exposure in air was not recovered by baking the cured film under nitrogen atmosphere.

1. A method for producing a quantum dot dispersion in which quantum dots (A) are dispersed in a dispersion medium (B), the method comprising:
dispersing the quantum dots (A) in the dispersion medium (B),
wherein a material of surface of the quantum dots (A) comprises a chalcogenide,
a ligand can bound to the surface of the quantum dots (A),
the dispersion medium (B) comprises an organic solvent (B1) comprising a chalcogen element.

2. The method for producing the quantum dot dispersion according to claim 1,
wherein the dispersing the quantum dots (A) in the dispersion medium (B) comprises:
preparing a preliminary dispersion containing the quantum dots (A) and a preliminary dispersion medium (pB), and
replacing the preliminary dispersion medium (pB) contained in the preliminary dispersion with the dispersion medium (B).

3. The method for producing the quantum dot dispersion according to claim 2,
wherein the replacing comprises:
removing at least a part of the preliminary dispersion medium (pB) from the preliminary dispersion,
adding the dispersion medium (B) to the mixture containing the quantum dots (A) and the remaining preliminary dispersion medium (pB), or quantum dots (A) after removal of the preliminary dispersion medium (pB).

4. The method for producing the quantum dot dispersion according to claim 3,
wherein the removal of the preliminary dispersion medium (pB) is conducted by volatilizing the preliminary dispersion medium (pB).

5. The method for producing the quantum dot dispersion according to claim 2,
wherein the replacing comprises:
preparing a liquid comprising the quantum dots (A), the dispersion medium (B), and a preliminary dispersion medium (pB) by adding the dispersion medium (B) to the preliminary dispersion, and
removing the preliminary dispersion medium (pB) from the liquid comprising the quantum dots (A), the dispersion medium (B), and the preliminary dispersion medium (pB).

6. The method for producing the quantum dot dispersion according to claim 1,
wherein the quantum dots (A) are heated at 50° C. or higher and 300° C. or lower in the presence of the organic solvent (B1) during or after production of the quantum dot dispersion.

7. The method for producing the quantum dot dispersion according to claim 1,
wherein a content of the organic solvent (B1) is 10 parts by mass or more and 2000 parts by mass or less relative to 100 parts by mass of the quantum dots (A) in the quantum dot dispersion.

8. A quantum dot dispersion in which quantum dots (A) are dispersed in dispersion medium (B),
wherein a material of surface of the quantum dots (A) comprises a chalcogenide, a ligand can bound to the surface of the quantum dots (A), and
the dispersion medium (B) comprises an organic solvent (B1) comprising a chalcogen element.

9. The quantum dot dispersion according to claim 8,
wherein a content of the organic solvent (B1) is 10 parts by mass or more and 2000 parts by mass or less relative to 100 parts by mass of the quantum dots (A) in the quantum dot dispersion.

10. The quantum dot dispersion according to claim 8,
wherein the quantum dot dispersion is blended into a coating liquid when preparing the coating liquid for producing a film containing quantum dots (A).
